(19) United States
(12) Patent Application Publication
(10) Pub. No.: US 2021/0161147 A1
(43) Pub. Date: Jun. 3, 2021

(54) BROAD SPECTRUM COSMETIC PRESERVATIVE SYSTEM

(71) Applicants: Melody Madeline Morrison, Simi Valley, CA (US); Victor Marius Lascu Constantinescu, Simi Valley, CA (US)

(72) Inventors: Melody Madeline Morrison, Simi Valley, CA (US); Victor Marius Lascu Constantinescu, Simi Valley, CA (US)

(21) Appl. No.: 16/699,557

(22) Filed: Nov. 30, 2019

(51) Int. Cl. A01N 59/16; A01N 41/10

(52) U.S. Cl. CPC A01N 59/16; A01N 41/10

(57) ABSTRACT

Disclosed is a broad-spectrum, antimicrobial preservative system composed of colloidal silver and an organic sulfur compound. This non-toxic preservative system is effective against both bacteria and fungi, while safe for the user and the environment. The two components can be mixed within a range of concentrations to function effectively.

### REFERENCE TO PRIOR APPLICATION

This application claims priority of the provisional patent application 62/792,392, filed Jan. 14, 2019 entitled BROAD SPECTRUM COSMETIC PRESERVATIVE SYSTEM by Melody Morrison.

### BACKGROUND OF THE INVENTION

### Field of the Invention

The present invention relates generally to the field of Microbicides such as in CPC section A01 N.

### Description of the Prior Art

This invention is for a novel, all-natural preservative system comprised of colloidal silver and an organic sulfur compound to be used in cosmetic products. According to the U.S. Pharmacopeia:

Antimicrobial preservatives are substances added to nonsterile dosage forms to protect them from microbiological growth or from microorganisms that are introduced inadvertently during or subsequent to the manufacturing process.

Most preservatives available to cosmetic formulators are comprised of toxic chemicals that are not naturally occurring in the environment. This is likely because a cosmetic preservatives must first and foremost effectively kill microorganisms. Ideally the preservative would also be suitable for exposure to the human skin, but this is of secondary importance in a market that is accustomed to shelf-stable and unquestionably preserved products. Formulators therefore must prioritize shelf stability and efficacy of preservation over sub-symptomatic damage to the human skin and body. Unfortunately many preservatives that are very effective at killing microbial life are likely detrimental to the skin and body of humans when used topically for the very reasons that they are effective at killing microorganisms. A preservative system that is effective at killing microorganisms yet is completely benign or beneficial to the human skin and body when applied topically is therefore very desirable within the cosmetic industry.

There are also natural preservatives available (with varying definitions of natural) that are less likely to be harmful to the human skin and body, but many are wanting in the areas of efficacy and stability. These natural preservatives often fail to arrest microbial growth across the full spectrum of microorganisms, which includes both bacteria and fungi (mold/yeast). Natural preservatives also often only slow microbial growth, relying on other ingredients to assist in the preservation of the product. Finally, natural preservatives often degrade more quickly than the more toxic chemical preservatives, undesirably reducing a product's shelf life.

The inventor has found that a combination of colloidal silver and an organic sulfur compound (e.g. methylsulfonylmethane [MSM]) successfully kills microbes per USP 51, Antimicrobial Effectiveness Test, demonstrating this combination to be an effective full-spectrum cosmetic preservative. Colloidal silver is notably effective at arresting bacterial growth, and organic sulfur compounds are notably effective at arresting fungal growth. When combined together at certain concentrations in an aqueous solution, the resulting mixture is highly effective at arresting the growth of both bacteria and fungi, making it a much-desired full spectrum preservative made of only natural, relatively harmless substances. The two components (colloidal silver and MSM) are found in nature, notably in ocean water, and are both relatively benign to the human skin and body when applied topically. MSM is a Generally Regarded As Safe (GRAS) approved substance. In addition, since they are both found naturally in the ocean, it can be deduced that this preservative is also harmless at some concentration to aquatic environments and therefore ecologically friendly compared to highly toxic conventional preservatives.

### SUMMARY OF THE INVENTION

The preferred embodiment of the present invention teaches an antimicrobial preservative composition comprising: a silver compound; a sulfur compound; and a solvent.

The above embodiment can be further modified by defining that said silver compound is colloidal silver.

The above embodiment can be further modified by defining that said silver compound is taken from the group comprising: silver nanoparticles, silver particle suspension, silver salts, ionic silver, organic silver compounds.

The above embodiment can be further modified by defining that the concentration of silver is between 1-1000 parts per million.

The above embodiment can be further modified by defining that said sulfor compound is taken from the group comprising: methylsulfonylmethane (MSM), dimethyl sulfoxide (DMSO), sodium methylsulfinylmethylilde (NaDMSO), methyl sulfone, dimethyl sulfone (DMSO₂), sulfonylbismethane, dimethyl sulfide (DMS), dimethyl sulfate, sulfolane, diethyl sulfoxide, dimethylsulfoniopropionate (DMSP), methanethiol, diethyl sulfite, methyl trifluoromethanesulfonate, methyl methanesulfonate (MMS), ethyl methanesulfonate (EMS) and any derivatives thereof.

The above embodiment can be further modified by defining that the concentration of said sulfur compound is between 0.1-50% w/w.

The above embodiment can be further modified by defining that said solvent is taken from the group comprising: water, alcohol, glycol, acetate, ether, ketone, aliphatic hydrocarbon, aromatic hydrocarbon and halogen substituted hydrocarbon solvent.

### DETAILED DESCRIPTION OF A PREFERRED EMBODIMENT

The preferred embodiment of the instant invention is described below.

The invented cosmetic preservative system consists of the combination of two substances, colloidal silver and an organic sulfur compound. While this provisional patent covers any organic sulfur compound, an example compound is methylsulfonylmethane (MSM) and will be used as a representative. Colloidal silver is a suspension of particles of silver in an aqueous solution. For the purpose of this provisional patent, the particles can be positively charged ionic silver, neutrally charged elemental silver, or silver particles bound to proteins. Colloidal silver has been known to be anti-microbial for over a century, and has a long history of use both internally and topically.

Methylsulfonylmethane (MSM) is a bioavailable form of sulfur. It is found in every plant and animal cell on earth, and is part of the natural sulfur cycle—dimethylsulfide (DMS) from decomposing organisms in the ocean reaches the ocean's surface and is oxidized by air and sunlight first into dimethylsulfoxide (DMSO), and then further into MSM. For commercial purposes, MSM is synthesized by oxidizing DMSO. While this source of MSM is synthetically derived, it is bio-identical to MSM found in nature. At high enough concentrations, MSM is anti-fungal in solution. Below this concentration, however, MSM is a nutritious form of sulfur for microorganisms and can actually augment microbial growth. Due to this concentration-dependent phenomenon, MSM readily becomes non-toxic to microbes when it is disbursed into the environment. It is also commonly taken at high doses (grams per day) in its pure form as a supplement, which is a testament to its benign, if not beneficial, effects on the human body.
For effective cosmetic preservation per USP 51, the inventor has found that a sufficient concentration of colloidal silver is 12.5 parts per million (ppm) and a sufficient concentration of MSM is 10% weight MSM over total weight (w/w) for an aqueous solution containing seaweed extract. The minimum concentrations of colloidal silver and MSM required to preserve different cosmetics, such as emulsions and less perishable aqueous solutions, is possibly lower and is intended to be covered by this provisional patent. For the sake of instruction, the above concentrations will be used to describe this invention.
Example use case: Using a final concentration of 12.5 ppm colloidal silver and 10% MSM (w/w) to preserve a 100 g aqueous solution. If the stock colloidal silver is 500 ppm, then 2.5 grams of the stock colloidal silver solution must be included in the 100 g final preparation to end up with 12.5 ppm colloidal silver ([12.5 ppm/500 ppm]*100 g=2.5 g). For 10% (w/w) MSM, 10 grams of MSM must be included in the 100g final preparation (100 g*0.1=10 g). The remaining weight, 87.5g, is the aqueous solution (100 g−10 g−2.5 g=87.5 g). Step 1: Add 2.5 g stock colloidal silver solution to 87.5 g aqueous solution and mix thoroughly. Step 2: Add 10 g MSM to the solution and mix until the MSM is fully dissolved. The 100 g of aqueous solution is now fully preserved with this novel preservative system.

The invention illustratively disclosed herein suitably may be practiced in the absence of any element which is not specifically disclosed herein.

The discussion included in this patent is intended to serve as a basic description. The reader should be aware that the specific discussion may not explicitly describe all embodiments possible and alternatives that are implicit. Also, this discussion may not fully explain the generic nature of the invention and may not explicitly show how each feature or element can actually be representative or equivalent elements. Again, these are implicitly included in this disclosure. Where the invention is described in device-oriented terminology, each element of the device implicitly performs a function. It should also be understood that a variety of changes may be made without departing from the essence of the invention. Such changes are also implicitly included in the description. These changes still fall within the scope of this invention.

Further, each of the various elements of the invention and claims may also be achieved in a variety of manners. This disclosure should be understood to encompass each such variation, be it a variation of any apparatus embodiment, a method embodiment, or even merely a variation of any element of these. Particularly, it should be understood that as the disclosure relates to elements of the invention, the words for each element may be expressed by equivalent apparatus terms even if only the function or result is the same. Such equivalent, broader, or even more generic terms should be considered to be encompassed in the description of each element or action. Such terms can be substituted where desired to make explicit the implicitly broad coverage to which this invention is entitled. It should be understood that all actions may be expressed as a means for taking that action or as an element which causes that action. Similarly, each physical element disclosed should be understood to encompass a disclosure of the action which that physical element facilitates. Such changes and alternative terms are to be understood to be explicitly included in the description.

What is claimed is:

1. An antimicrobial preservative composition comprising:
a silver compound;
a sulfur compound;
and a solvent.

2. The antimicrobial preservative composition as defined in claim 1 wherein said silver compound is colloidal silver.

3. The antimicrobial preservative composition as defined in claim 1 wherein said silver compound is taken from the group comprising: silver nanoparticles, silver particle suspension, silver salts, ionic silver, organic silver compounds.

4. The antimicrobial preservative composition as defined in claim 1 wherein the concentration of silver is between 1-1000 parts per million.

5. The antimicrobial preservative composition as defined in claim 1 wherein said sulfor compound is taken from the group comprising:
methylsulfonylmethane (MSM), dimethyl sulfoxide (DMSO), sodium methylsulfinylmethylilde (NaDMSO), methyl sulfone, dimethyl sulfone (DMSO₂), sulfonylbismethane, dimethyl sulfide (DMS), dimethyl sulfate, sulfolane, diethyl sulfoxide, dimethylsulfoniopropionate (DMSP), methanethiol, diethyl sulfite, methyl trifluoromethanesulfonate, methyl methanesulfonate (MMS), ethyl methanesulfonate (EMS) and any derivatives thereof.

6. The antimicrobial preservative composition as defined in claim 1 wherein the concentration of said sulfur compound is between 0.1-50% w/w.

7. The antimicrobial preservative composition as defined in claim 1 wherein said solvent is taken from the group comprising: water, alcohol, glycol, acetate, ether, ketone, aliphatic hydrocarbon, aromatic hydrocarbon and halogen substituted hydrocarbon solvent.
